(19) United States
(12) Patent Application Publication
(10) Pub. No.: US 2004/0012244 A1
(43) Pub. Date: Jan. 22, 2004

(54) Device to protect vehicle wheels and axles from debris

(76) Inventors: Terry M. Waterman, Paradis, LA (US); Orville H. Waterman, Paradis, LA (US)

Correspondence Address: Richard C. Litman, LITMAN LAW OFFICES, LTD., P.O. Box 15035, Arlington, VA, 22215, US

(21) Appl. No.: 10/619,491

(22) Filed: Jul. 16, 2003

Related U.S. Application Data
(60) Provisional application No. 60/396,095, filed on Jul. 17, 2002.

(51) Int. Cl. B60B 7/00

(52) U.S. Cl. 301/37.101

(57) ABSTRACT

An annular plate is attached to a drum-type wheel so that the interior of the wheel is no longer exposed to the outside environment. The outside circumference of the plate is connected either to the edges of the drum or to the inner sidewalls that connect the drum to the hub. The inside circumference of the plate is connected to the wheel hub or hub extension. Gussets located on the outside of the plate deflect debris. If the plate is made from heavy material, such as structural steel, it will protect the sidewalls from operational, environmental damage.

### CROSS-REFERENCE TO RELATED APPLICATION

This application claims the benefit of U.S. Provisional Patent Application Serial No. 60/396,095, filed Jul. 17, 2002.

### BACKGROUND OF THE INVENTION

1. Field of the Invention

The present invention relates to heavy equipment wheels and more specifically to a device mounted inside a wheel drum to keep debris or dirt from building up inside the wheel or around a vehicle axle.

2. Description of Related Art

Drum-type wheels consist of a hollow outer cylindrical drum, an inner cylindrical hub, and two inner sidewalls to connect the drum to the hub. The inner sidewalls are generally conical in shape. Because the sidewalls are conical in shape, they meet the hub at an acute angle, thus forming a crevice between the hub and the sidewall where trash could build up.

Wheels on trash compactor vehicles face serious environmental assault. Because these vehicles operate in dumpsites, the wheels are exposed to wire, cable, sharp metal objects, and various other types of debris. This debris tends to get wrapped around the wheel axles, to get stuck inside the wheels, or to puncture or otherwise damage the sidewalls. To avoid mechanical breakdown of the wheels, this debris must be removed on a continual basis. However, due to the design of most wheels and the relative position in which they are mounted on the vehicles, the wheels must be removed in order to clear the debris. For trash compactor wheels, this process takes two men over eight hours and necessitates the use of heavy equipment. Moreover, the trash compactor vehicle is out of service during this debris removal process.

A discussion of the related art follows:

U.S. Pat. No. 5,676,493, issued on Oct. 14, 1997, to R. J. Brockway, describes a wheel with an access panel on its outer side. The access panel is large enough to allow a person to insert their head and arms in order to remove debris accumulated on the inner side of the wheel without having to remove the wheel.

U.S. Pat. Nos. 5,330,260, issued on Jul. 19, 1994, 5,451,100, issued on Sep. 19, 1995, and 5,553,932, issued on Sep. 10, 1996, to E. Freeman describe installing cutter blades on the axle and the sidewall in order to cut refuse before it can build up on the axle.

U.S. Pat. No. 6,045,295, issued on Apr. 4, 2000, to J. E. Puchosic, describes using a wheel-mounted hook member to ensnare debris, and an axle-mounted serrated blade to sever debris before it reaches the wheel axle.

U.S. Pat. No. 2,146,882, issued on Feb. 14, 1939, to D. B. Baker et al., describes a conical shield to protect sprockets on a crawler-type tractor.

U.S. Pat. No. 4,379,565, issued on Apr. 12, 1983, to C. F. Riddle, describes an annular deflector plate mounted around the axle housing of a compaction vehicle.

U.S. Pat. No. 5,733,020, issued on Mar. 31, 1998 to R. A. McCartney et al., describes an axle shield attached to the vehicle to cover the inner portion of a wheel for inhibiting wire, cable and the like from entangling the axle assembly of a compactor vehicle.

U.S. Pat. No. 6,076,843, issued on Jun. 20, 2000, to J. P. Sewell, describes the attachment of a guard member composed of plates around the axle assembly of a landfill compactor vehicle. These plates are intended to reduce the amount of debris getting wrapped around the axle assemblies.

U.S. Pat. No. 5,769,507, issued on Jun. 23, 1998, to R. J. Brockway, describes a compactor wheel axle guard system comprising a ring that encircles the outer edge of the wheel, and that acts to deflect debris.

Patents that show axle shrouds include U.S. Pat. No. 5,951,123, issued on Sep. 14, 1999, to D. W. Bomstad et al. showing a guard assembly attached to the axle and rotating with the wheel; U.S. Pat. No. 5,967,242, issued on Oct. 19, 1999, to J. O. Caron et al. describing a shroud covering the axle of a compactor vehicle; and U.S. Pat. No. US 6,322,170 B1, issued on Nov. 27, 2001, to H. A. Knell et al. showing curved guards attached to the vehicle body to protect the axle.

Patents that show scrapers include U.S. Pat. No. 4,818,040, issued on Apr. 4, 1989, to E. J. Mezzancella et al. describing a scraper plate parallel to the axle that scrapes debris as the wheel rotates, and U.S. Pat. No. 5,967,630, issued on Oct. 19, 1999, to J. P. Sewell describing a scraper that attaches to the vehicle body or the axle.

The present invention solves the above-mentioned problems by firstly, covering some or all of the sidewall with a plate. Because a plate is approximately planar, it joins the hub at a right angle. Furthermore, the plate meets the sidewall at approximately a right angle or greater, thus avoiding a new problem of trash build up in a crevice near the outer rim.

Secondly, to further minimize trash build up, the present invention includes gussets mounted on the plate to sweep trash away from the wheels.

Thirdly, the present invention is made of thicker material than the prior art to prevent trash from puncturing through the plate.

None of the above inventions and patents, taken either singly or in combination, is seen to describe the instant invention as claimed.

### SUMMARY OF THE INVENTION

An annular plate is attached to a drum-type wheel so that the interior of the wheel is no longer exposed to the outside environment. The outside circumference of the plate is connected either to the edges of the drum or to the inner side walls that connect the drum to the hub. The inside circumference of the plate is connected to the hub or hub extension. The plate is substantially perpendicular to the drum and the axis of rotation. Welding and gussets were used to hold the plate in place. These gussets can be located either (1) on the outside of the plate or (2) on the inside of the plate. If located on the outside of the plate, the gussets will also serve as debris deflectors. If the plate is made from heavy material, such as structural steel, it will protect the sidewalls from operational, environmental damage.

Accordingly, it is a principal object of the invention to protect the sidewalls of a drum-type wheel from environmental assault by sharp objects.

It is a further object of the invention to reduce the amount of trash becoming trapped in the wheel rims.

Still another object of the invention is to deflect debris away from the wheel and axle of a vehicle, such as a landfill compactor vehicle.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a landfill compacting vehicle in shadow showing the inner side of a wheel employing one embodiment of the present invention.

FIG. 2 is a perspective view of a prior art wheel.

FIG. 3 is an exploded, unassembled, perspective view of a first embodiment of the present invention.

FIG. 4 is an assembled view of the FIG. 3 apparatus.

FIG. 5 is an exploded, unassembled, perspective view of the second embodiment of the present invention.

FIG. 6 is an assembled view of the FIG. 5 apparatus.

FIG. 7 is a cross-sectional view of the FIG. 4 apparatus showing a wheel employing the present invention.

Similar reference characters denote corresponding features consistently throughout the attached drawings.

### DETAILED DESCRIPTION OF THE PREFERRED EMBODIMENTS

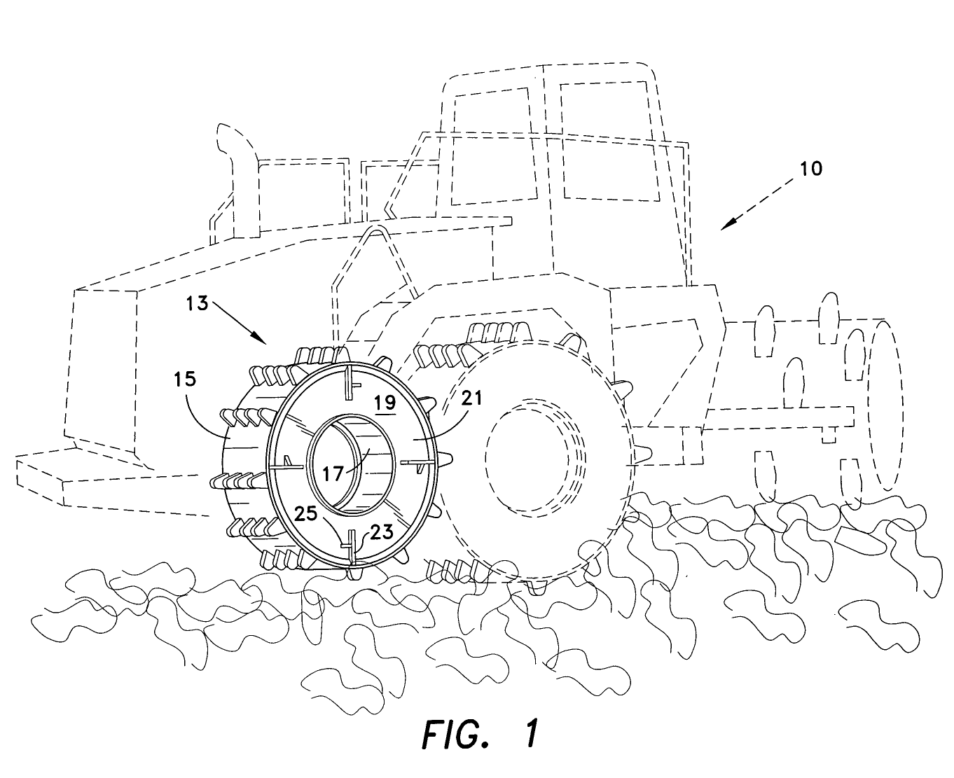

A first embodiment of the present invention is illustrated in FIG. 1 on a farm tractor 10 as an annular planar plate 21 that mounts inside a drum-type wheel 13 consisting of a drum 15, a hub 17, and sidewall 19. Four trapezoidal shaped gussets 23 supported individually by a smaller triangular gusset 25 are mounted diametrically and spaced 90 degrees apart on the planar plate 21 to deflect debris. The smaller supporting triangular shaped gussets 25 provide adequate support to the trapezoidal gussets 23.

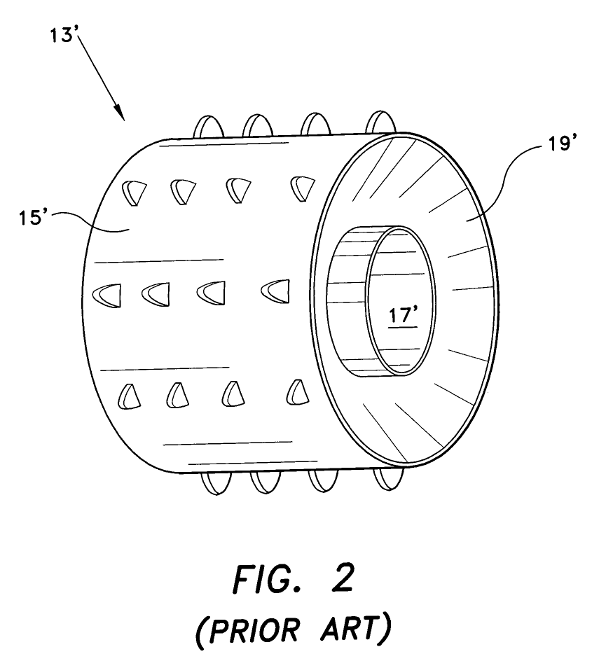

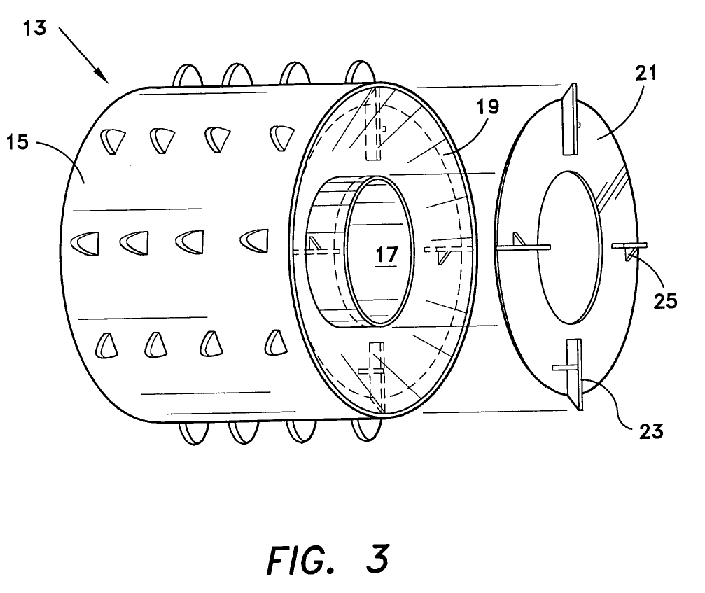

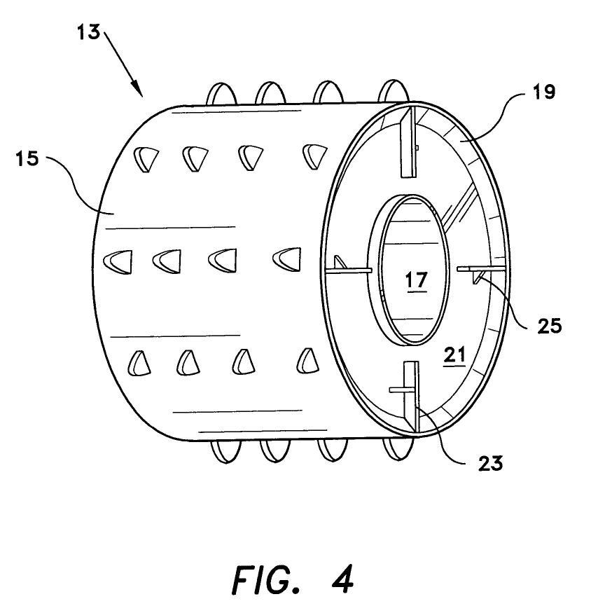

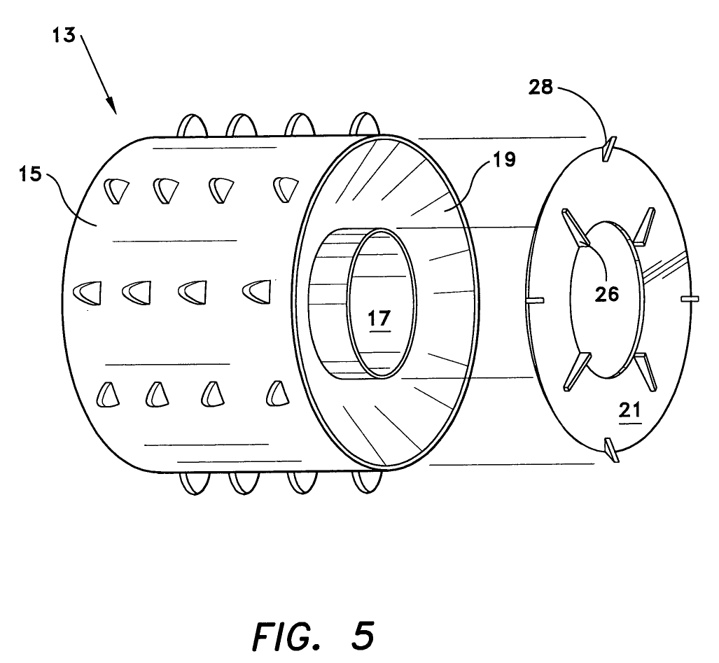

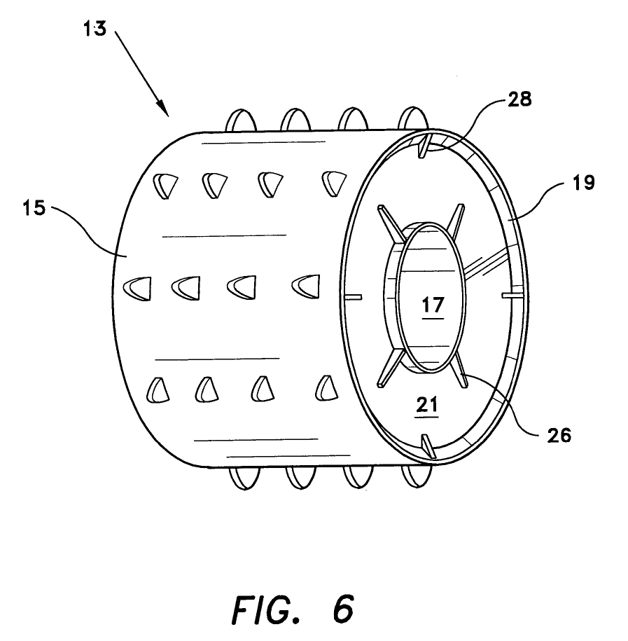

FIG. 2 depicts the prior art drum-type wheel 13′ having a drum 15′ with a concave sidewall 19′ that would inherently collect debris readily around the hub 17′. The two embodiments illustrated in FIGS. 3 and 4 (first embodiment) and FIGS. 5 and 6 (second embodiment) are designed to fit wheels for Caterpillar landfill compactor vehicles having model numbers: Cat 826G and Cat 836. The shape of the gussets 23 and 25 was easily adapted to these individual vehicle peculiarities. Thus, the invention could be used on most, if not all, drum-type wheels of any vehicle.

In the preferred first embodiment depicted in FIGS. 3 and 4, the annular plate 21 is made of ½-inch thick structural steel. The gussets 23 supported by 25 are made of an inch thick structural steel. Referring to FIGS. 3 and 5, the plate 21 is placed around the hub 17. Referring to FIG. 4 and FIG. 6, the inner circumference of the plate 21 is welded to the outside of the hub 17, and the outside circumference of the plate 21 is welded to the sidewalls 19 of the wheel 13.

In the first embodiment of FIGS. 3 and 4, the gussets 23 are trapezoidal in shape and their non-parallel sides are welded equidistantly onto the plate 21 and sidewalls 19 of the wheel 13 at right angles to the drum 15. Small supporting gussets 25 are triangular in shape and are welded onto the plate 21 and the trapezoidal gussets 23.

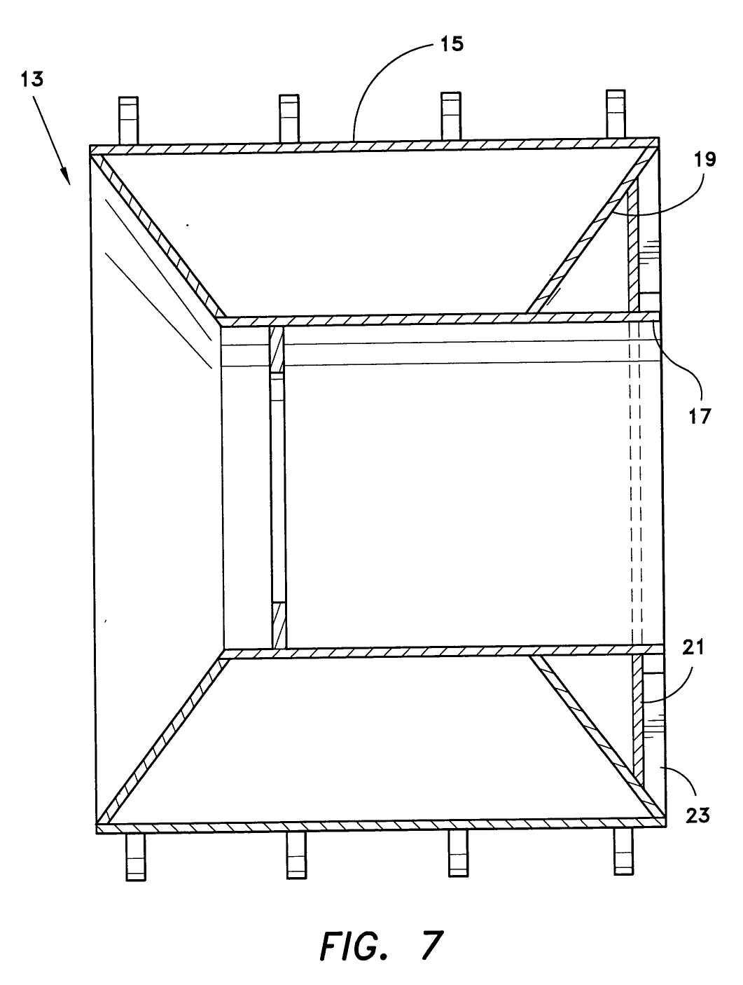

In the cross-sectional view of the FIG. 4 wheel depicted in FIG. 7, the first embodiment wheel 13 having a drum 15 and a concave sidewall 19 surrounding the hub 17 is protected by an annular plate 21 supported by gussets 23.

In the second embodiment, referring to the drum 15 in FIGS. 5 and 6, a first set of four equidistantly spaced small gussets 28 are triangular in shape, and welded onto the plate 21 and to the sidewall 19 of the wheel 13. A second set of four equidistantly spaced larger gussets 26 are welded to the plate 21, arranged 45 degrees askew from the first set of gussets 28, and perpendicularly abut the hub 17.

Thus, two embodiments of a modification of the conventional debris catching wheels have been shown to result in much less debris being caught by the innovative wheels.

It is to be understood that the present invention is not limited to the sole embodiments described above, but encompasses any and all embodiments within the scope of the following claims.

We claim:

1. A debris protective device for vehicle wheels and axles, comprising:
an annular planar device, made of structurally resilient material, mounted inside a wheel, and extending from the outside circumference of a wheel hub toward the outer rim of the wheel drum, and dimensioned and configured such that the inner sidewalls of the wheel are protected by peripheral projections from environmental assault by debris.

2. The debris protective device according to claim 1, wherein the peripheral projections are gussets attached to the outside of the device in order to deflect debris away from the wheel and axle.

3. The debris protective device according to claim 2, wherein the gussets are spaced equidistantly.

4. The debris protective device according to claim 2, wherein the gussets are spaced 90 degrees apart.

5. The debris protective device according to claim 2, wherein the gussets have a trapezoidal shape with a non-parallel side adapted to abut the outer rim of the wheel drum.

6. The debris protective device according to claim 5, including a smaller gusset attached perpendicularly to the trapezoidal gusset.

7. The debris protective device according to claim 6, wherein the smaller gusset has a shape of a right angle triangle.

8. The debris protective device according to claim 4, wherein a first set of gussets have a triangular shape, a certain size and perpendicularly abut the outer rim of the wheel drum.

9. The debris protective device according to claim 8, including a second set of gussets having an elongated shape greater in length than said first set of gussets, having a truncated trapezoidal shape, and positioned 45 degrees askew from the first set of gussets and abutting the wheel hub.

10. The debris protective device according to claim 9, wherein the second set of gussets are positioned perpendicular to the wheel hub.
